(19) United States
(12) Patent Application Publication
(10) Pub. No.: US 2006/0008773 A1
(43) Pub. Date: Jan. 12, 2006

(54) Titanium-mesh umbrella device for bone grafting

(76) Inventor: Jung-Yen Liao, Hua-Lien (TW)

Correspondence Address: BUCKNAM AND ARCHER, 1077 NORTHERN BOULEVARD, ROSLYN, NY, 11576, US

(21) Appl. No.: 10/886,854

(22) Filed: Jul. 8, 2004

(51) Int. Cl. A61C 8/00

(52) U.S. Cl. 433/173

(57) ABSTRACT

A titanium-mesh umbrella for bone grafting used to combine with conventional implant and to hold bone graft in proper position during dental implant placement procedure, comprises: a titanium metal shank with one end as implant end and the other end having a pin hole at its center to form a mounting portion; a titanium-mesh with its surface having a plurality of screen meshes, wherein said titanium-mesh encircles an area with a diameter in horizontal direction and forms a projecting umbrella surface with a curvature in perpendicular direction, a rough surface being formed on said projecting umbrella surface, said umbrella type titanium-mesh being able to position quickly on the mounting portion of said metal shank to form an umbrella structure. Thus, the titanium metal umbrella can be positioned quickly during dental implant placement procedure, so that the guide tissue membrane can be securely attached, a space for bone graft growing can be maintained, and the operation duration can be shortened.

### BACKGROUND OF THE INVENTION

(1) Field of the Invention

This invention relates to a titanium-mesh umbrella deivce for alveoloplasty, especially to a structure of titanium-mesh umbrella for bone grafting, which can be positioned quickly during dental implant placement procedure to hold bone graft in proper position, and to maintain a bone graft space and the easy covering of a guide tissue membrane, and to shorten the operation duration.

(2) Description of the Related Art

In a method for treating a missing tooth in traditional dentistry, the outline of either tooth of its neighbors has to be grinded into smaller shape so as to form an abutment for consolidation of a crown bridge for fixing a prosthesis. However, there are many disadvantages in traditional method, such as the damage of enamel on healthy teeth of both neighbors, uneasiness for cleaning, bad looking of the metal clasp exposure, easiness of loosing of implant and bad masticatory capability etc. In recent years, the principle of osseointegration and dental implant is able to yield remarkable change in dentist clinical treatment. More clearly speaking, dental implant means that a titanium implant is implanted by surgical operation into the alveolar bone at the position where the tooth is missing, so as to form an artificial tooth root, i.e., implant which can provide a reliable consolidated base for the mounting of a prosthesis. After the implant is closely combined with alveolar bone, a denture can be mounted onto the base of the implant to function as a substitute for natural tooth. Due to the fact that the implant body is deeply inserted into the alveolar bone, it can load normal masticatory stress without any connection with adjacent natural dentition, and keep pace with natural dentition both in function as well as aesthetic.

As shown in FIG. 1, conventional dental implant placement procedure is of a two-steps type. In step one, dentist implants, by surgical operation, a cylindrical implant body (20) made by pure titanium into alveolar bone (10) at the alveolar ridge (1) of missing tooth. Then, bone graft (21) (e.g. hydroxyapatite or bone graft of various type) is filled into the alveolar bone (10) so as to consolidate the artificial tooth root. The bone graft (21) will be subjected to pressure during stitching process, which will result in deformation of the bone graft (21), before the bone graft (21) is cured and closely combined with the alveolar bone (10). Usually, dentist will first cut a piece of titanium mesh (22) with suitable size and put the titanium mesh (22) onto the surface of the alveolar bone (10) to hold the bone graft (21) in proper position. A biological barrier membrane (23) is laid on the surface of the titanium mesh (22) for healing and prevents the gingival soft tissue around the alveolar bone (10) from growing into the bone, as this will cause bone healing incomplete. In normal condition, the tooth hole within the alveolar bone (10) is filled with bone graft after a period of 4-6 months of healing, the implant has been under self osseointegration. Then, the second stage of implant placement is processed, wherein a firm abutment and prosthesis is securely mounted on the artificial tooth root.

In ideal case, the development of the principle of dental implant and its application in clinic, including implant material, healing principle of surgery, prosthesis designing and medicine control, has reached to a level of their maturity. However, the abovementioned conventional titanium mesh still has some defects, in other words, the conventional titanium mesh still has room for further improvements in clinic application. It is to be understood by those who are skillful in this field that titanium mesh is usually produced in large area configuration. A dentist has to carry out some pre-fabrication processes, such as cutting into suitable size, trimming delicately into desired size according to clinic condition, before it can be applied to the area to be treated. This pre-fabrication process not only extends operation duration, but also requires much efforts in the fixation of said titanium mesh, as there is no any structure in said titanium mesh for positioning, yet dentist has to take strenuous effort even in the fixation of using multiple mini-screws. In addition, the titanium mesh is easily displaced during stitching procedure, which will result in the shifting of the guide tissue membrane in healing process. Furthermore, the surface of titanium mesh is smooth so that a guide tissue membrane is not easy to adhere to the surface. Based on foregoing, there are troublesome procedures and increasing difficulties in using the conventional titanium mesh.

### SUMMARY OF THE INVENTION

Therefore, the main object of this invention is to provide an titanium-mesh umbrella device for bone grafting, wherein the titanium-mesh can be positioned in place quickly during an implant placement procedure, so that, through the combination with the artificial tooth root, the deficiencies in conventional dental implant, such as requiring bone grafting and complicated procedure, can be significantly improved.

The present invention will be accomplished by an titanium-mesh umbrella device for bone grafting. The present invention comprises a metal shank which has one end part as an implant end and the opposite end part has an aperture at the center of its end surface to form as a mounting portion; a titanium-mesh with its surface having a number of meshes, wherein said titanium-mesh defines an area with a diameter in horizontal direction and forms a convex umbrella surface with a curvature in the perpendicular direction, a rough surface being formed on said convex umbrella surface, and a leg being formed on the bottom surface and extending in downward direction, said metal leg being mounted at the underside of said titanium-mesh to form an umbrella configuration, to the effect that said mounting portion of the shank is securely cannulated in said leg. Thus, said titanium-mesh umbrella is able to insert into the mounting portion of the implant metal insert quickly so as to be able to provide a pressureless space for the bone graft to cure and avoid distortion, to shorten the surgery duration, to ensure that the bone graft will not loss in healing, and to ensure that the guide tissue membrane will not slip or shift from original place.

According to the present invention, the surface of the titanium-mesh umbrella is provided with a plurality of projections to form a rough surface which can be formed either by etching or by casting work, for enhancing attachment capability, so that the guide tissue membrane will securely attach to said surface without any slipping or displacement happened. Therefore, the surgical process can be simplified and the fixation by mini-screw can be eliminated, which is another object of present invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a conventional dental implant technology wherein an embodiment of artificial implant is shown;

FIG. 2 is a schematic front view showing the first embodiment of the titanium-mesh umbrella device for bone grafting of present invention;

FIG. 2a is a schematic plane view of FIG. 2;

FIG. 2b is a schematic sectional view taken along line 2b-2b of FIG. 2a;

FIG. 3 is view showing a demonstration example of the application of the titanium-mesh umbrella device for bone grafting of present invention in dental implant;

FIG. 4 is a schematic front view showing the second embodiment of the titanium-mesh umbrella device for bone grafting of present invention;

FIG. 4a is a schematic plane view of FIG. 4;

FIG. 4b is a schematic sectional view taken along line 4b-4b of FIG. 4a;

FIG. 5 is a derivative variation of the first embodiment of present invention;

FIG. 6 is s a derivative variation of the second embodiment of present invention

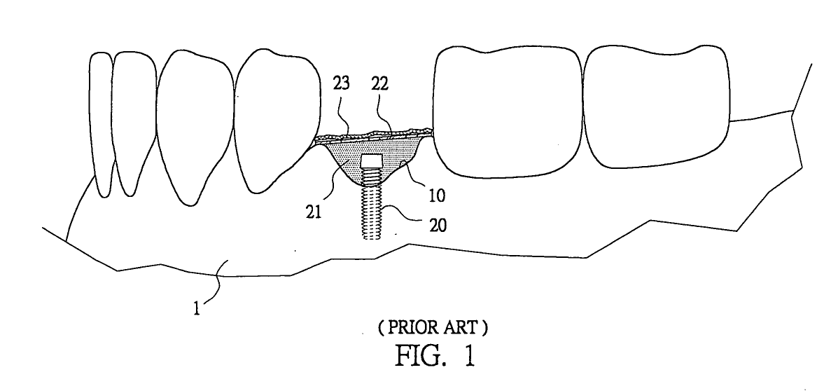

### DESCRIPTION OF THE PREFERRED EMBODIMENT

In view of the biocompatibility of the titanium, i.e.,the ability not to be rejected to combine with the bone cell within bone, the titanium metal implant can be closely integrated with the alveolar ridge to be secured within the jaw bone. The implant body concerned with present invention utilizes titanium as the primary material. While above objects and advantages of present invention will be further described with preferred embodiments of this invention, said embodiments is for illustrative purpose only and should not be considered as limitative. This invention will become more apparent with the following detailed description of preferred embodiments by reference to the accompanied drawings.

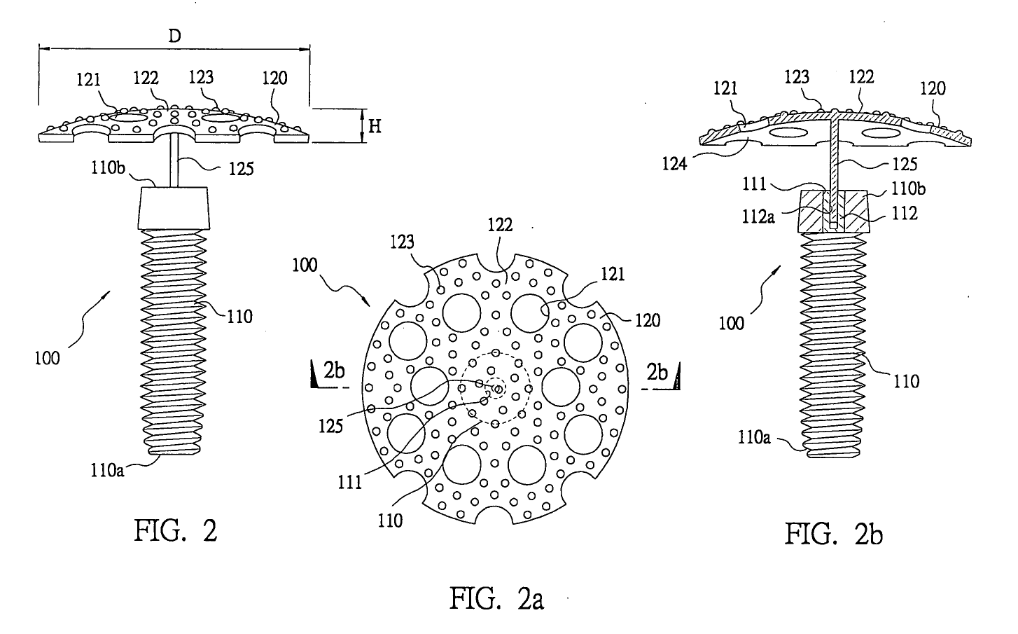

FIG. 2 is the first embodiment of the titanium-mesh umbrella device for bone grafting of present invention, wherein FIG. 2a is a top view, FIG. 2b is sectional view taken along the line 2b-2b in FIG. 2a. As shown in FIG. 2˜2b, the titanium-mesh umbrella device 100 for bone grafting of present invention comprises a metal shank 110, which is a tooth root-shaped cylindrical body made by titanium, the first end 110a of which is a end for implant. Usually, the first end 110a of the metal shank 110 has a thread to enhance anchored capability for deeply implanted into the alveolar bone. The second end 110b has an axial pin hole at its center to form a mounting portion 111 used to fix a denture. A titanium-mesh 120 is made by titanium into sheet form, the surface of which is provided with a plurality of screen meshes 121 for air-permeable purpose and for activating the implant and bone graft area. Said titanium-mesh 120 encircles an area with a diameter D in horizontal direction, which can be adjusted according to the location of treated tooth, and forms a umbrella surface 122, projecting with a height H, with a curvature in perpendicular direction, a rough surface 123 being formed with dense granule-shaped projections on said projecting umbrella surface 122 for the purpose of enhancing the surface attachment capability. In addition, a leg 125 is formed in the bottom 124 and extending in vertical direction. According to present invention, the mounting portion 111 of the metal shank 110 is provided with a plastic block 112, the center of which contains a pin hole 112a. The leg 125 of the titanium-mesh 120 can be inserted into the pin hole 112a of the plastic block 112 of the mounting portion 111 of the metal shank 110, so that it can be positioned in place quickly to form an umbrella configuration.

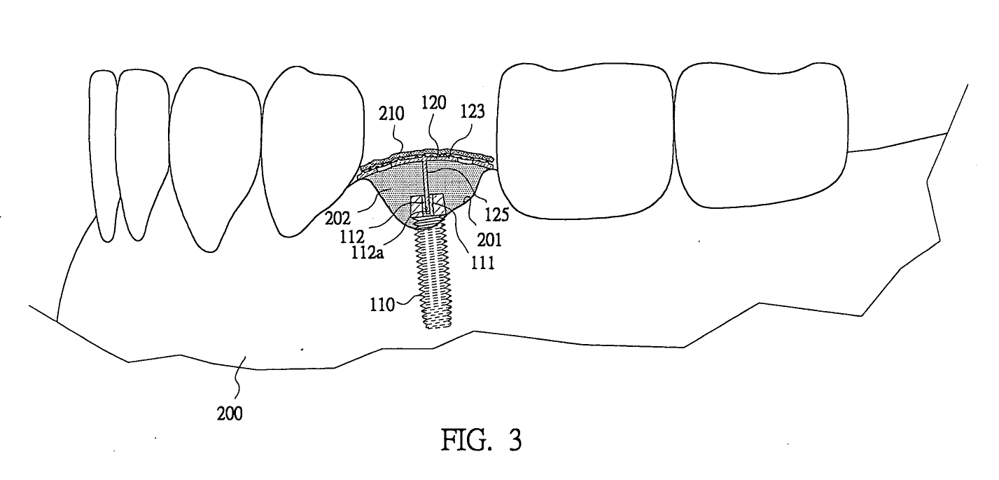

FIG. 3 is an example for demonstration showing the application of the titanium-mesh umbrella device of the present invention during the dental implant placement process. In step one, dentist implants, by surgical process, a metal shank 110 into alveolar bone 201 at the edentulous ridge 200, and then, bone graft 202 (e.g. hydroxyapatite or bone graft of various animals) is filled into the alveolar bone 201 so as to consolidate the metal shank 10. At the same time, the leg 125 of the titanium-mesh 120 is inserted and fixed into the pin hole 112a of the plastic block 112 of the mounting portion 111 of the metal shank 110, so that the titanium-mesh 120 is laid onto the surface of the alveolar bone 201 to hold the bone graft 202 in proper position. Then, after a biological barrier membrane 210 is laid onto the rough surface 123 of the umbrella type titanium-mesh 120, stitching process is undergone for the healing of the surface.

According to this invention, the leg 125 at the bottom 124 of the umbrella type titanium-mesh 120 is inserted and fixed quickly into the mounting portion 111 of the implant metal shank 110 during the implant placement process, so that the bone graft 202 is not distorted and compressed during stitching process. Thereby, the time required for surgery operation can be reduced, and the shift of the guide tissue membrane caused by the umbrella type titanium-mesh 120 can be avoided. Simultaneously, because the guide tissue membrane 210 is securely attached to the rough surface 123 of the titanium-mesh 120 without any slipping or shift happened, the stitching during surgery operation can be undergone easily. After a period of 4-6 months for healing, the tooth hole within the alveolar bone 201 is filled with artificial tooth root, then step two can be undergone. In other words, a rigid prosthesis is mounted on the mounting portion 111 based on the metal shank 110.

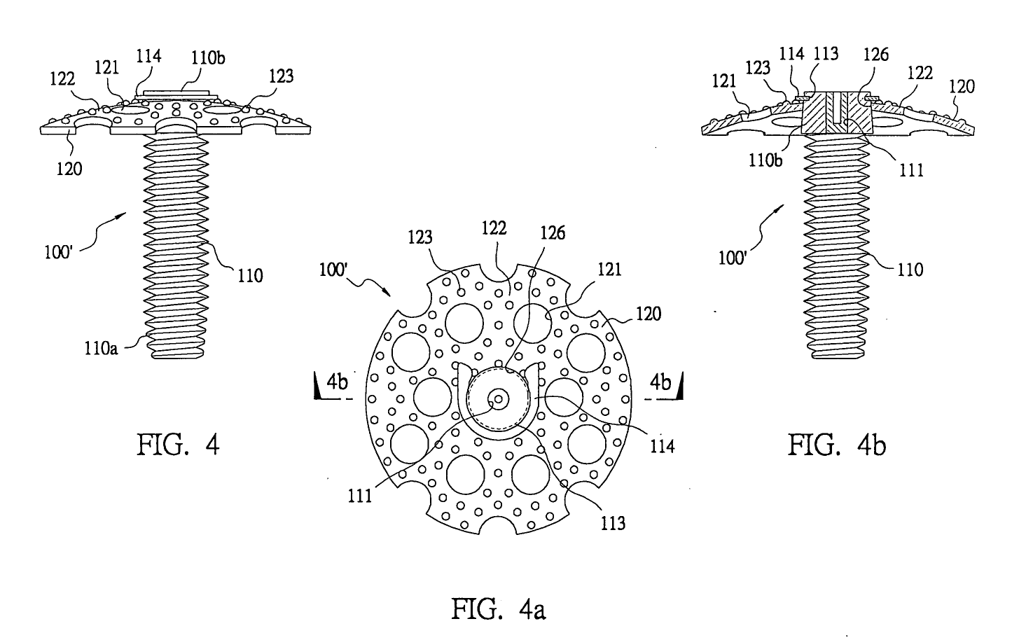

FIG. 4 is the second embodiment of the titanium-mesh umbrella device for bone grafting of present invention, wherein FIG. 4a is a top view, FIG. 4b being a sectional view taken along a line 4b-4b of FIG. 4a. Basically, this embodiment has the same structure as that of the above first embodiment, therefore, detailed description is omitted. The difference between this embodiment and the first embodiment lies on the method of combination between the titanium-mesh 120 and the metal shank 110. As shown in FIG. 4˜4b, a locating hole 126 is formed at the center of the surface 122 of the titanium-mesh 120, which is used to combine with the metal shank 110 to form an umbrella configuration. A peripheral groove 113 is formed along the periphery of the end portion of the second end 110b of the metal shank 110. After the locating hole 126 of the titanium-mesh 120 is inserted through the second end 110b, a U-shaped retainer ring 114 is inserted into the peripheral groove 113 for the fixation of the titanium-mesh 120 on the metal shank 110. Therefore, both of titanium-mesh 120 and the metal shank 110 can be positioned easily and combined with each other quickly.

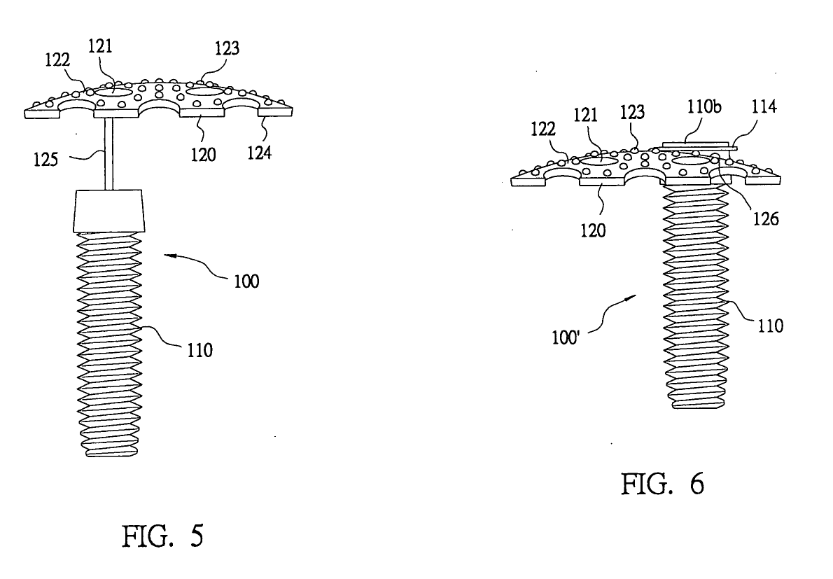

With the same concept, it is noted here to those who are skillful in this field, that the tooth hole in the alveolar bone, after the extraction of a decayed tooth, is not necessarily a symmetrical shape. Dentist might set the dental implant eccentrically depending on the requirement of each case. FIG. 5 and FIG. 6 are examples of variations derivated from this invention. As shown in FIG. 5, the leg 125 can be placed at a location outside of the center in the bottom 124 of the titanium-mesh 120, so as to combine with the metal shank 110 to form an eccentric umbrella structure. Similarly, in FIG. 6, the locating hole 126 can be provided at a predetermined point outside the center of the titanium-mesh 120, so as to combine with the metal shank 110 to form an eccentric umbrella structure. In addition, in abovementioned embodiments, the surface of the umbrella titanium-mesh 120 is provided with a rough surface 123 in the form of granule-like projections, or which can be formed either by etching or by casting work.

The abovementioned are merely preferred embodiments of present invention, which is not considered as a limitation to the range of this invention. It will be understood by those who are skillful in this field that titanium material can be substituted by any other biocompatible materials. In other words, all equivalent modifications and variations made without departing from the scope defined by the appended claims of present invention should be considered within the coverage of present invention.

In summary, the titanium-mesh umbrella device for bone grafting of present invention can be inserted and fixed, during dental implant placement process, into the mounting portion of the implant metal shank quickly for the consolidation of bone graft, so that the guide tissue membrane can be securely attached to the surface of the umbrella without any slipping happened. Therefore, stitching during surgery process can be undergone very easily, the operation duration being reduced, the shift of the guide tissue membrane caused by the umbrella type titanium-mesh 120 being avoided, and the growing space for bone graft being provided. Thus, this invention is a novel invention with inventive steps and industrial availability.

### LIST OF NUMERALS FOR MAJOR COMPONENTS

100 titanium-mesh umbrella device for bone grafting of this invention
110 metal shank
110a first end
110b second end
111 mounting portion
112 plastic block
113 peripheral groove
114 U-shaped retainer ring
120 titanium-mesh
121 pin hole
122 surface of the umbrella
123 rough surface
124 bottom
125 leg
126 locating hole
200 alveolar ridge
201 alveolar bone
202 bone graft
210 guide tissue membrane

What is claimed is:

1. A titanium-mesh umbrella device (100), for combination with implant body and holding bone graft in proper position during dental implant placement procedure, comprising: a metal shank (110) with a end part (110a) as an implant end and a opposite second end part (110b) having an pin hole at the center of its surface end to form a mounting portion (111); a titanium-mesh (120) with its top surface having a number of meshes (121), wherein said titanium-mesh (120) defines an area with a diameter(D) in horizontal direction and forms a convex umbrella surface (122) projecting with a height H, with a curvature in perpendicular direction, said convex surface (123) being roughed on the top surface of the convex surface (122), a leg (125) being formed on the bottom surface (124) and extending in vertical direction; said titanium-mesh (120) combining with the opposite end part of said metal shank (110) to form an umbrella configuration, and said leg (125) being inserted and fixed into said mounting porting (111).

2. A titanium-mesh umbrella device (100) as claimed in claim 1, wherein said metal shank (110) and said titanium-mesh (120) are made of titanium metal material.

3. A titanium-mesh umbrella device (100) as claimed in claim 1, wherein said leg (125) is positioned at the center of the bottom (124) of said umbrella type titanium-mesh (120).

4. A titanium-mesh umbrella device (100) as claimed in claim 1, wherein said leg (125) is positioned at a location outside the center of the bottom (124) of said umbrella type titanium-mesh (120).

5. A titanium-mesh umbrella device (100) as claimed in claim 1, wherein a plastic block (112) is provided between said titanium-mesh (120) and said leg (125), within said mounting portion (111) of said metal shank (110).

6. A titanium-mesh umbrella device (100) as claimed in claim 1, wherein a rough surface (123) with a plurality of projections is formed on the surface of said titanium-mesh (120).

7. A titanium-mesh umbrella device (100) as claimed in claim 1, wherein a rough surface (123) is formed on the surface of said titanium-mesh (120) by etching.

8. A titanium-mesh umbrella device (100) as claimed in claim 1, wherein a rough surface (123) is formed on the surface of said titanium-mesh (120) by press work.

9. A titanium-mesh umbrella device (100′), for combination with implant body and holding bone graft in proper position during dental implant placement procedure, comprising: a metal shank (110) with a end part (110a) as an implant end and an opposite end part (110b) having an pin hole at the center of its surface end to form a mounting portion (111); a titanium-mesh (120) with its top surface having a number of meshes (121), wherein said titanium-mesh (120) defines an area with a diameter(D) in horizontal direction and forms a convex umbrella surface (122),projecting with a height(H), with a curvature in perpendicular direction, said convex surface (123) being roughed on the top surface of the convex surface (122), a locating hole (126) being formed at a predetermined point of said convex surface (122); said titanium-mesh (120) combining at the opposite end part of said metal shank (110) to form an umbrella configuration, and said locating hole (126) being inserted and fixed on the second end (110b) of said metal shank (110).

10. A titanium-mesh umbrella device (100′) as claimed in claim 9, wherein said locating hole (126) is positioned at the center of said titanium-mesh (120).

11. A titanium-mesh umbrella device (100′) as claimed in claim 9, wherein said locating hole (126) is positioned at a predetermined point outside the center of said titanium-mesh (120).

12. A titanium-mesh umbrella device (100′) as claimed in claim 9, wherein said metal shank (110) and said titanium-mesh (120) are made of titanium metal material.

13. A titanium-mesh umbrella device (100′) as claimed in claim 9, wherein a rough surface (123) with a plurality of projections is formed on the surface of said titanium-mesh (120).

14. A titanium-mesh umbrella device (100′) as claimed in claim 9, wherein a rough surface (123) is formed on the surface of said titanium-mesh (120) by etching.

15. A titanium-mesh umbrella device (100′) as claimed in claim 9, wherein a rough surface (123) is formed on the surface of said titanium-mesh (120) by casting work.
